(19) United States
(12) Patent Application Publication
(10) Pub. No.: US 2018/0190019 A1
(43) Pub. Date: Jul. 5, 2018

(54) AUGMENTED REALITY USER INTERFACE VISIBILITY

(71) Applicant: DAQRI, LLC, Los Angeles, CA (US)

(72) Inventors: Rory Glynn, Dalkey (IE); Lucas Kazansky, Los Angeles, CA (US); Christopher Michaels Garcia, Whittier, CA (US); Stefanie A. Hutka, Los Angeles, CA (US)

(21) Appl. No.: 15/393,255

(22) Filed: Dec. 29, 2016

(51) Int. Cl. G06T 19/00; G06T 11/60; G02B 27/01; G02B 27/00

(52) U.S. Cl. CPC G06T 19/006; G06T 11/60; G02B 27/0172; G02B 2027/0118; G02B 2027/0138; G02B 2027/014; G02B 27/0093

(57) ABSTRACT

A device includes a display, an optical sensor, and an augmented reality (AR) application. The optical sensor captures an image. The AR application determines visual properties of a region of the image, the region being adjacent to a portion of the AR content. The AR application determines visual properties of the AR content, determines a contrast between the region in the image and the AR content based on the visual properties of the region in the image and the AR content, and modifies an appearance of the AR content based on the contrast.

### TECHNICAL FIELD

The subject matter disclosed herein generally relates to an augmented reality device. Specifically, the present disclosure addresses systems and methods for improving user interface visibility in augmented reality devices.

### BACKGROUND

An augmented reality (AR) device can be used to generate and display data in addition to an image captured with the AR device. For example, AR is a live, direct, or indirect view of a physical, real-world environment whose elements are augmented by computer-generated sensory input such as sound, video, graphics or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

Virtual content can be displayed as a layer on top of a real-world physical object associated with the virtual content. However, the visibility of the virtual content can be affected based on the appearance or color of both the virtual content and the real-world physical object. For example, it may be difficult for a user of the AR device to perceive a virtual content having a color similar to the color of the real-world physical object.

### BRIEF DESCRIPTION OF THE DRAWINGS

Some embodiments are illustrated by way of example and not limitation in the figures of the accompanying drawings.

FIG. 1 is a block diagram illustrating an example of a network suitable for an augmented reality system, according to some example embodiments.

FIG. 2 is a block diagram illustrating an example embodiment of a head mounted device.

FIG. 3 is a block diagram illustrating an example embodiment of sensors.

FIG. 4 is a block diagram illustrating an example embodiment of a user interface visibility module.

FIG. 5 is a block diagram illustrating an example embodiment of a user interface display controller.

FIG. 6 is a flowchart illustrating a method for adjusting an appearance of a user interface, according to an example embodiment.

FIG. 7 is a flowchart illustrating a method for adjusting an appearance of a user interface, according to another example embodiment.

FIG. 8 is a block diagram illustrating an example of adjusting a visibility of a user interface, according to some example embodiments.

FIG. 9 is a block diagram illustrating another example of adjusting a visibility of a user interface, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to an augmented reality (AR) device. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

An AR device includes, for example, a wearable device such as a head-mounted device. A user wearing the AR device can see virtual content or objects through transparent lenses. The virtual content appears to be overlaid on top of real-world objects in the transparent lenses. However, virtual content that includes colors or shapes similar to the colors or shapes of the real-world objects that appear behind the virtual content can be difficult to distinguish. For example, it may be challenging for a user to discriminate a blue graphical user interface (GUI) of a virtual content when it is perceived as overlaid on top of a blue physical object. In another example, red text in a GUI displayed over a red button can be difficult to read.

The present application describes a process for increasing visibility of AR interfaces such as GUI in changing environments. For example, the AR device senses ambient light levels and adjusts the font or theme setting of an AR interface to render the AR interface more visible. Other systems vary the brightness of the entire display or screen to improve visibility in addition to adjusting the color, shape, or brightness of individual elements in the AR interface.

In one example embodiment, an AR device includes a display, an optical sensor, and an augmented reality (AR) application. The optical sensor captures an image. The AR application determines visual properties of a region in the image. For example, the region is adjacent to a portion of the AR content displayed in the display. The AR application determines visual properties of the AR content, determines a contrast level between the region in the image and the AR content based on the visual properties of the region in the image and the AR content, and modifies an appearance of the AR content based on the contrast level. In another example, the AR application adjusts the brightness, color, size, shape, and font of the AR content based on a combination of the pupil dimension of the user of the device and the contrast level.

In another example embodiment, the AR device includes a helmet (or any other head-mounted apparatus) with a display surface that can be retracted inside the helmet and extended outside the helmet to allow a user to view the display surface. The position of the display surface may be adjusted based on an eye level of the user. The display surface includes a display lens capable of displaying augmented reality (AR) content. The helmet may include a computing device such as a hardware processor with an AR application that allows the user wearing the helmet to view information, such as in the form of a virtual object such as a three-dimensional (3D) virtual object overlaid on an image or a view of a physical object (e.g., a gauge) captured with a camera in the helmet. The helmet may include optical sensors. The physical object may include a visual reference (e.g., a recognized image, pattern, or object, or unknown objects) that the AR application can identify using predefined objects or machine vision. A visualization of the additional information (also referred to as AR content), such as the 3D virtual object overlaid or engaged with a view or an image of the physical object, is generated in the display lens of the helmet.

The display lens may be transparent to allow the user to see through the display lens. The display lens may be part of a visor or face shield of the helmet or may operate independently from the visor of the helmet. The 3D virtual object may be selected based on the recognized visual reference or captured image of the physical object. A rendering of the visualization of the 3D virtual object may be based on a position of the display relative to the visual reference. Other AR applications allow the user to experience visualization of the additional information overlaid on top of a view or an image of any object in the real physical world. The virtual object may include a 3D virtual object and/or a two-dimensional (2D) virtual object. For example, the 3D virtual object may include a 3D view of an engine part or an animation. The 2D virtual object may include a 2D view of a dialog box, menu, or written information such as statistics information for properties or physical characteristics of the corresponding physical object (e.g., temperature, mass, velocity, tension, stress). The AR content (e.g., image of the virtual object, virtual menu) may be rendered at the helmet or at a server in communication with the helmet. In one example embodiment, the user of the helmet may navigate the AR content using audio and visual inputs captured at the helmet or other inputs from other devices, such as a wearable device. For example, the display lenses may extend or retract based on a voice command of the user, a gesture of the user, or a position of a watch in communication with the helmet.

In another example embodiment, a non-transitory machine-readable storage device may store a set of instructions that, when executed by at least one processor, causes the at least one processor to perform the method operations discussed within the present disclosure.

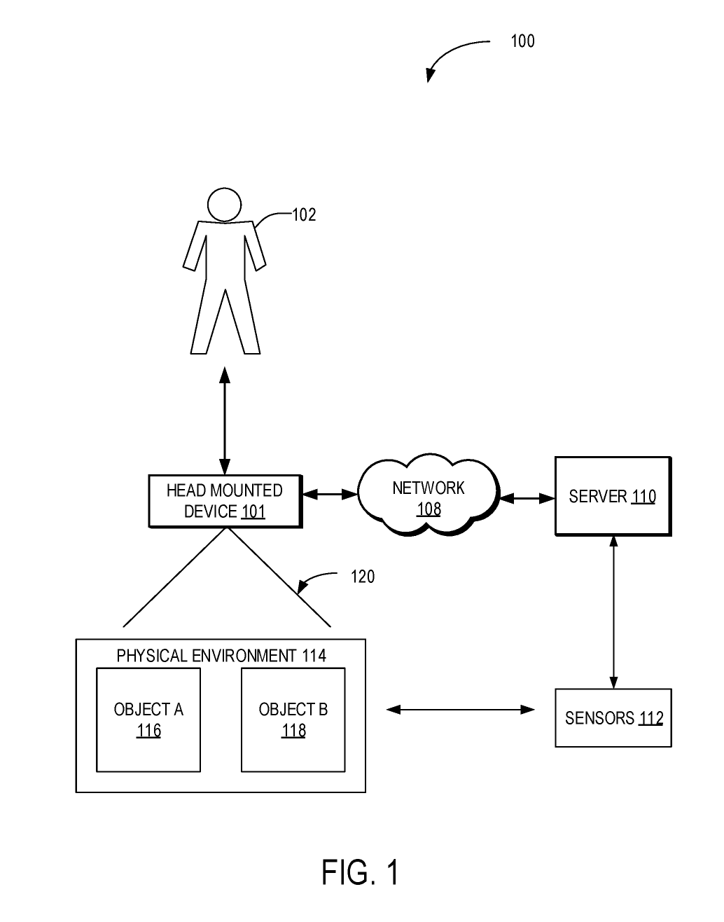

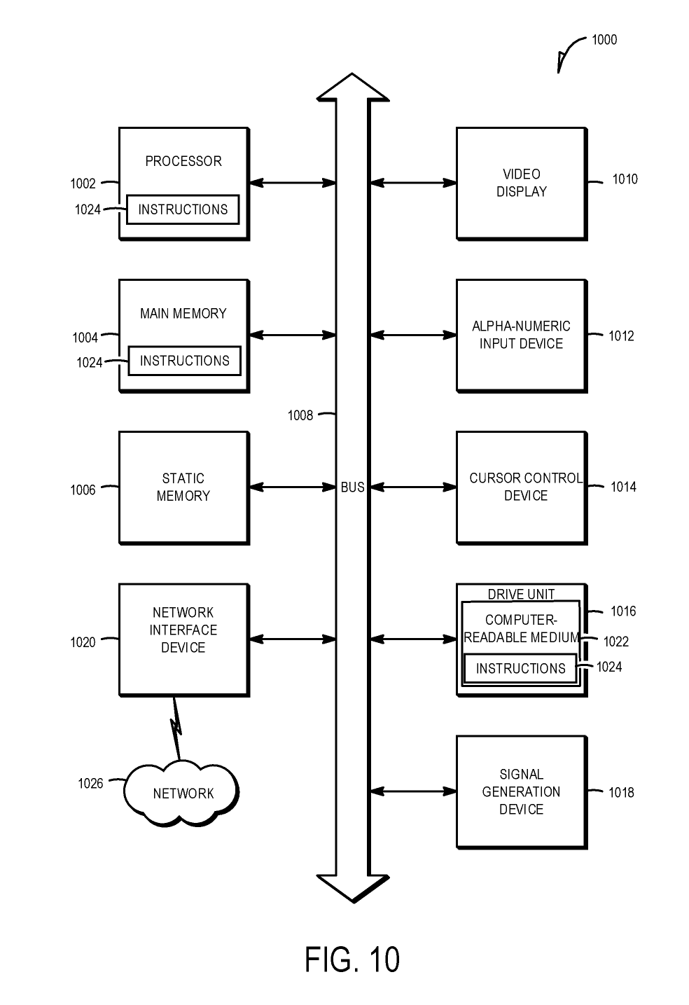

FIG. 1 is a network diagram illustrating a network environment 100 suitable for operating an AR system, according to some example embodiments. The network environment 100 includes a head-mounted device (HMD) 101 and a server 110, communicatively coupled to each other via a network 108. The HMD 101 and the server 110 may each be implemented in a computer system, in whole or in part, as described below with respect to FIG. 10.

The server 110 may be part of a network-based system. For example, the network-based system may be or include a cloud-based server system that provides AR content (e.g., graphical user interface, or augmented information including 3D models of virtual objects related to physical objects captured by the HMD 101) to the HMD 101.

The HMD 101 may include a helmet that a user 102 may wear to view the AR content related to captured images of several physical objects (e.g., object A 116, object B 118) in a real-world physical environment 114. In one example embodiment, the HMD 101 includes a computing device with a camera and a display (e.g., smart glasses, smart helmet, smart visor, smart face shield, smart contact lenses). The computing device may be removably mounted to the head of the user 102. In one example, the display may be a screen that displays what is captured with a camera of the HMD 101. In another example, the display of the HMD 101 may be a transparent or semi-transparent surface, such as in the visor or face shield of a helmet, or a display lens distinct from the visor or face shield of the helmet.

The user 102 may be a user of an AR application in the HMD 101 and at the server 110. The user 102 may be a human user (e.g., a human being), a machine user (e.g., a computer configured by a software program to interact with the HMD 101), or any suitable combination thereof (e.g., a human assisted by a machine or a machine supervised by a human). The user 102 is not part of the network environment 100, but is associated with the HMD 101. The AR application may provide the user 102 with an AR experience triggered by identified objects in the physical environment 114. The physical environment 114 may include identifiable objects such as a 2D physical object (e.g., a picture), a 3D physical object (e.g., a factory machine), a location (e.g., at the bottom floor of a factory), or any references (e.g., perceived corners of walls or furniture) in the real-world physical environment 114. The AR application may include computer vision recognition to determine corners, objects, lines, and letters. The user 102 may point a camera of the HMD 101 to capture an image of the objects 116 and 118 in the physical environment 114.

In one example embodiment, the objects 116, 118 in the image are tracked and recognized locally in the HMD 101 using a local context recognition dataset or any other previously stored dataset of the AR application of the HMD 101. The local context recognition dataset module may include a library of virtual objects associated with real-world physical objects 116, 118 or references. In one example, the HMD 101 identifies feature points in an image of the objects 116, 118 to determine different planes (e.g., edges, corners, surface, dial, letters). The HMD 101 may also identify tracking data related to the objects 116, 118 (e.g., GPS location of the HMD 101, orientation, distances to objects 116, 118). If the captured image is not recognized locally at the HMD 101, the HMD 101 can download additional information (e.g., 3D model or other augmented data) corresponding to the captured image, from a database of the server 110 over the network 108.

In another embodiment, the objects 116, 118 in the image are tracked and recognized remotely at the server 110 using a remote context recognition dataset module or any other previously stored dataset of an AR application in the server 110. The remote context recognition dataset module may include a library of virtual objects or augmented information associated with real-world physical objects 116, 118 or references.

Sensors 112 may be associated with, coupled to, or related to the objects 116 and 118 in the physical environment 114 to measure a location, information, or measured readings of the objects 116 and 118. Examples of measured readings may include and but are not limited to weight, pressure, temperature, velocity, direction, position, intrinsic and extrinsic properties, acceleration, and dimensions. For example, sensors 112 may be disposed throughout a factory floor to measure movement, pressure, orientation, and temperature. The server 110 can compute readings from data generated by the sensors 112. The server 110 can generate virtual indicators such as vectors or colors based on data from sensors 112. Virtual indicators are then overlaid on top of a live image of the objects 116 and 118 to show data related to the objects 116 and 118. For example, the virtual indicators may include arrows with shapes and colors that change based on real-time data. The visualization may be provided to the HMD 101 so that the HMD 101 can render the virtual indicators in a display of the HMD 101. In another embodiment, the virtual indicators are rendered at the server 110 and streamed to the HMD 101. The HMD 101 displays the virtual indicators or visualization corresponding to a display of the physical environment 114 (e.g., data is visually perceived as displayed adjacent to the objects 116 and 118).

The sensors 112 may include other sensors used to track the location, movement, and orientation of the HMD 101 externally without having to rely on the sensors 112 internal to the HMD 101. The sensors 112 may include optical sensors (e.g., depth-enabled 3D camera), wireless sensors (Bluetooth, Wi-Fi), GPS sensor, and audio sensors to determine the location of the user 102 having the HMD 101, distance of the user 102 to the tracking sensors 112 in the physical environment 114 (e.g., sensors 112 placed in corners of a room), the orientation of the HMD 101 to track what the user 102 is looking at (e.g., direction at which the HMD 101 is pointed, e.g., HMD 101 pointed towards a player on a tennis court, HMD 101 pointed at a person in a room, etc.).

In another embodiment, data from the sensors 112 and internal sensors in the HMD 101 may be used for analytics data processing at the server 110 (or another server) for analysis on usage and how the user 102 is interacting with the physical environment 114. Live data from other servers may also be used in analytics data processing. For example, the analytics data may track at what locations (e.g., points or features) on the physical or virtual object the user 102 has looked, how long the user 102 has looked at each location on the physical or virtual object, how the user 102 moved with the HMD 101 when looking at the physical or virtual object, which features of the virtual object the user 102 interacted with (e.g., such as whether a user 102 tapped on a link in the virtual object), and any suitable combination thereof. The HMD 101 receives a visualization content dataset related to the analytics data. The HMD 101 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., HMD 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

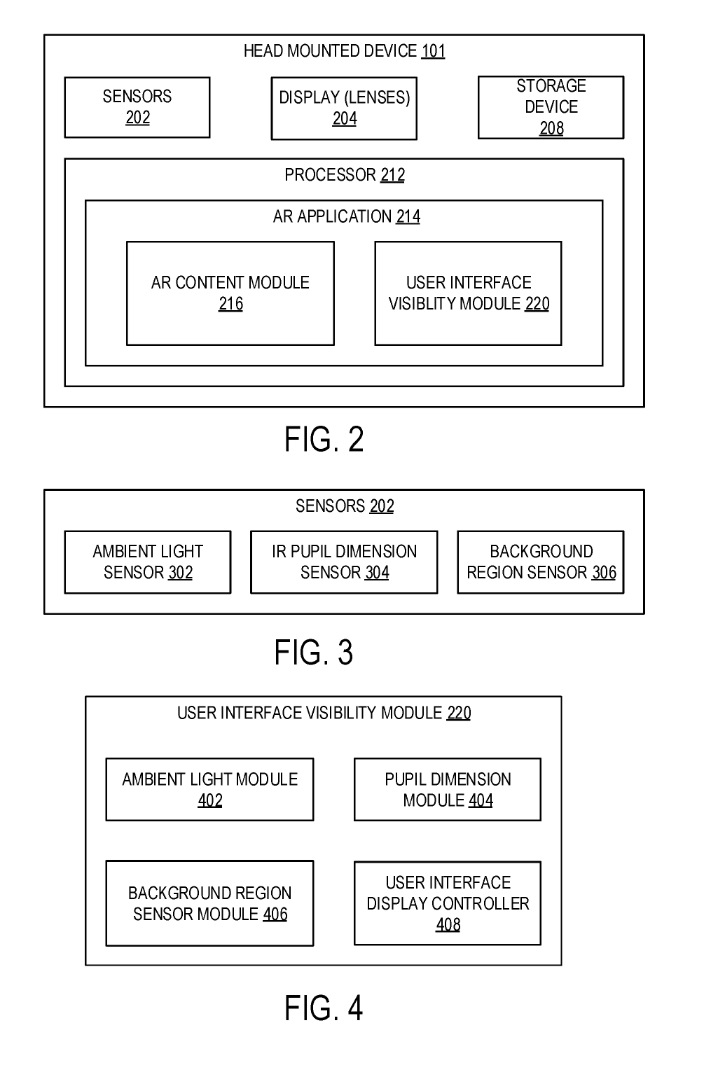

FIG. 2 is a block diagram illustrating modules (e.g., components) of the HMD 101, according to some example embodiments. The HMD 101 may be a helmet that includes sensors 202, a display 204, a storage device 208, and a processor 212.

The sensors 202 may include, for example, a proximity or location sensor (e.g., near field communication, GPS, Bluetooth, Wi-Fi), an optical sensor(s) (e.g., camera), an orientation sensor(s) (e.g., gyroscope, or an inertial motion sensor), an audio sensor (e.g., a microphone), neuro sensors (e.g., EEG sensors), or any suitable combination thereof. For example, the sensors 202 may include rear facing camera(s) and front facing camera(s) disposed in the HMD 101. It is noted that the sensors 202 described herein are for illustration purposes. Sensors 202 are thus not limited to the ones described. The sensors 202 may be used to generate internal tracking data of the HMD 101 to determine what the HMD 101 is capturing or looking at in the real physical world. For example, a GUI may be activated when the sensors 202 indicate that the HMD 101 is oriented in a particular direction (e.g., when the user 102 tilts his head to look at his wrist).

FIG. 3 illustrates example embodiments of sensors 202. For example, the sensors 202 include an ambient light sensor 302, an infrared (IR) pupil dimension sensor 304, and a background region sensor 306. The ambient light sensor 302 includes an optical sensor that determines an ambient luminosity. For example, the ambient light sensor 302 measures the ambient light in a room where the HMD 101 is located. Therefore, the HMD 101 uses the ambient light sensor 302 to determine whether the HMD 101 is located in a dim or bright room or place.

The IR pupil dimension sensor 304 includes an infrared sensor directed towards an eye of the user 102 to measure the size of the pupil of the user 102. The IR pupil dimension sensor 304 may sample the size of the pupil on a periodic basis or based on predefined triggered events (e.g., user 102 walks into a different room, sudden changes in the ambient light or eye gaze direction of the user 102).

The background region sensor 306 captures an image of what the user 102 is looking at. For example, the background region sensor 306 includes a camera that captures an image of the physical environment 114 in the real world within the field of view 120 of the user 102. As illustrated in FIG. 1, the captured image includes images of physical objects 116 and 118.

Referring back to FIG. 2, the display 204 may include a display surface or lens capable of displaying AR content (e.g., graphic user interface, virtual content, images, video) generated by the processor 212. In another embodiment, the display 204 can include a touchscreen display configured to receive a user input via a contact on the touchscreen display. In another example, the display 204 may be transparent or partially transparent so that the user 102 can see through the display 204 (e.g., such as in a head-up display).

The storage device 208 may store a database of identifiers of AR devices capable of communicating with the HMD 101. In another embodiment, the database may also include visual references (e.g., images) and corresponding experiences (e.g., GUI, 3D virtual objects, interactive features of the 3D virtual objects). The database may include a primary content dataset, a contextual content dataset, and a visualization content dataset. The primary content dataset includes, for example, a first set of images and corresponding experiences (e.g., interaction with 3D virtual object models). For example, an image may be associated with one or more virtual object models. The primary content dataset may include a core set of images or the most popular images determined by the server 110. The core set of images may include a limited number of images identified by the server 110. For example, the core set of images may include the images depicting covers of the ten most viewed devices and their corresponding experiences (e.g., virtual objects that represent the ten most sensing devices on a factory floor). In another example, the server 110 may generate the first set of images based on the most popular or often scanned images received at the server 110. Thus, the primary content dataset does not depend on objects 116, 118 or images scanned by the HMD 101.

The contextual content dataset includes, for example, a second set of images and corresponding experiences (e.g., three-dimensional virtual object models) retrieved from the server 110. For example, images captured with the HMD 101 that are not recognized (e.g., by the server 110) in the primary content dataset are submitted to the server 110 for recognition. If the captured image is recognized by the server 110, a corresponding experience may be downloaded at the HMD 101 and stored in the contextual content dataset. Thus, the contextual content dataset relies on the contexts in which the HMD 101 has been used. As such, the contextual content dataset depends on objects or images scanned by the HMD AR application 214 of the HMD 101.

In one embodiment, the HMD 101 may communicate over the network 108 with the server 110 to retrieve a portion of a database of visual references, corresponding 3D virtual objects, and corresponding interactive features of the 3D virtual objects.

The processor 212 may include an AR content module 216 and a user interface visibility module 220. The AR content module 216 generates a display of information (e.g., GUI) related to the physical environment 114, or the objects 116, 118. For example, the AR content module 216 generates a visualization of information (in the form of text or graphics) related to the objects 116, 118 when the HMD 101 captures an image of the objects 116, 118 and recognizes the objects 116, 118 or when the HMD 101 is in proximity to the objects 116, 118. For example, the HMD AR application 214 may generate a display of a holographic or virtual menu or GUI visually perceived as a layer on the objects 116, 118.

The user interface visibility module 220 adjusts the appearance or visual properties (e.g., color, font, shape, brightness) of the GUI based on properties of the background image (e.g., color, brightness, pattern). For example, the user interface visibility module 220 increases the size of the font or changes the theme of the GUI based on the background region on which the GUI is displayed. If the background region is dark, the user interface visibility module 220 changes the text font of the GUI to be white or increases the size of the text to match the size of the background region. In another example, the user interface visibility module 220 increases the brightness of elements of the GUI over the background region.

In one example embodiment, the user interface visibility module 220 includes an ambient light module 402, a pupil dimension module 404, a background region sensor module 406, and a user interface display controller 408 as illustrated in FIG. 4. The ambient light module 402 communicates with the ambient light sensor 302 in the HMD 101 to identify and measure ambient light around the HMD 101. For example, the ambient light sensor 302 measures a light intensity of the environment around the HMD 101. The pupil dimension module 404 communicates with the infrared (IR) pupil dimension sensor 304 to measure a size of the pupil of the user 102.

The background region sensor module 406 communicates with the background region sensor 306 to measure a size and location of a background region in an image captured by the background region sensor 306. For example, the background region includes an area corresponding to the GUI in the display 204. The area may be larger than the area including the GUI. For example, if the GUI includes a rectangular box, the area includes a rectangular area that is ten percent larger than the area of the rectangular box.

The user interface display controller 408 controls and adjusts the GUI. For example, the user interface display controller 408 controls and adjusts the visual properties of the GUI based on the measured ambient light, the pupil dimensions of the user 102, visual properties of the background region, and the visual properties of the GUI. For example, the user interface display controller 408 increases the brightness of the GUI (by controlling the display 204) if the pupil size is below a lower predefined size threshold. The user interface display controller 408 adjusts the brightness of the GUI incrementally until the pupil size falls within a preset range. In another example, the brightness of the GUI may be decreased if the pupil size is above an upper predefined size threshold.

In another example embodiment, the user interface display controller 408 determines a contrast level between the GUI and the background region based on the visual properties of the GUI and the background region, the ambient light, and the pupil dimensions of the user 102. For example, the contrast level is determined by comparing the brightness of the GUI with the brightness of the background region. The contrast level may also factor in the ambient light. In another example, the contrast level is determined by comparing color similarities between the GUI and the background region. In other examples, the contrast level is determined by comparing GUI shapes, sizes, colors, font, theme with the background region.

The user interface display controller 408 may increase or decrease the size of the font in the GUI to increase visibility over a background region of similar or different color. The user interface display controller 408 may change the font in the GUI to increase font visibility over a background region with graphics that resemble original fonts in the GUI. The user interface display controller 408 can change the shape of the GUI or adjust a size of the GUI to increase visibility over a background region based on the shape similarities in the background region. For example, if the background region includes images of bubbles, the user interface display controller 408 adjusts the GUI to include rectangular boxes so as to increase visibility over the image of bubbles. If the background region includes black and white patterns, the user interface display controller 408 adjusts the GUI to include colorful dialog boxes so as to increase visibility over the black and white patterns. In another example, the user interface display controller 408 changes the location when the GUI is to be displayed in the display 204. For example, the user interface display controller 408 displays the GUI in an area or region where the background region provides the most contrast.

In another example embodiment, the user interface display controller 408 controls and adjusts the visual properties of the GUI based on the neuro sensors or biological sensors connected to the user. For example, the user interface display controller 408 may render the GUI larger or brighter based on a detection by the neuro sensors that the user is not as attentive or is becoming sleepy.

Any one or more of the modules described herein may be implemented using hardware (e.g., a processor 212 of a machine) or a combination of hardware and software. For example, any module described herein may configure a processor 212 to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

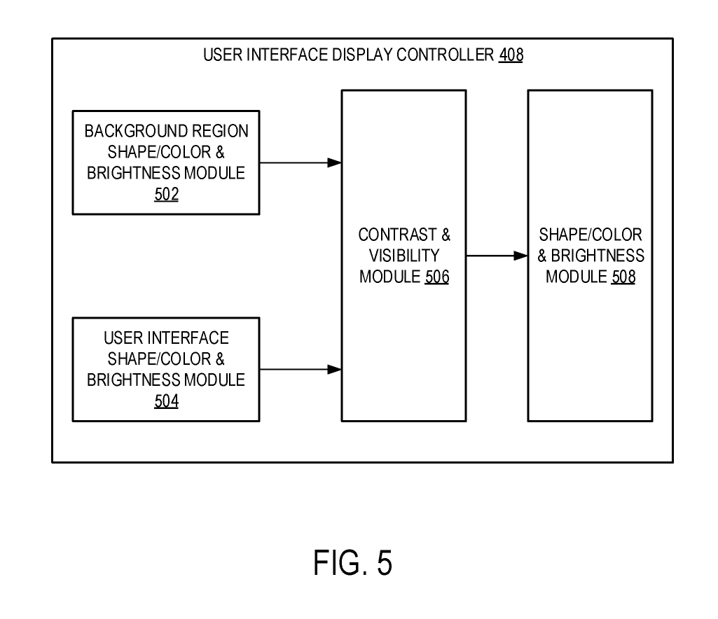

FIG. 5 is a block diagram illustrating an example embodiment of the user interface display controller 408. The user interface display controller 408 includes a contrast and visibility module 506 that determines a contrast level based on visual properties data from a background region shape, color, and brightness module 502 and visual properties data from a user interface shape, color, and brightness module 504. The shape, color, and brightness module 508 receives the contrast level data from the contrast and visibility module 506 and adjusts visual properties of the graphical user interface to increase the contrast level. For example, the shape, color, and brightness module 508 renders the graphical user interface with a darker font color over a white background region. In another example, the shape, color, and brightness module 508 modifies the graphical user interface to be presented in a geometric pattern that is distinct and easily visually distinguished and perceived over the background region. In another example, the shape, color, and brightness module 508 increases the brightness of the graphical user interface. In another example, the shape, color, and brightness module 508 changes the location of the GUI in the display to increase the contrast level between the GUI and the background image (e.g., image captured by the background region sensor 306).

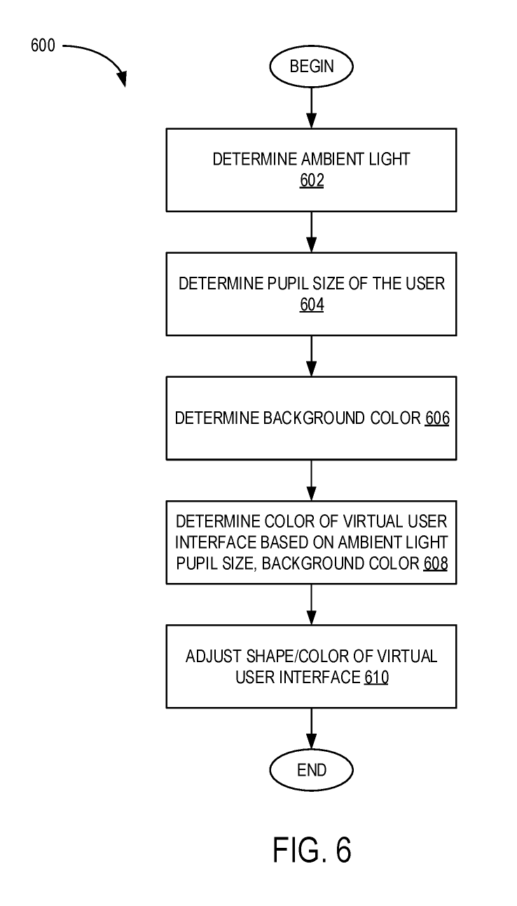

FIG. 6 is a flowchart illustrating a method 600 for adjusting an appearance of a user interface, according to an example embodiment. At operation 602, the user interface visibility module 220 of FIG. 2 determines an ambient light to the HMD 101. At operation 604, the user interface visibility module 220 determines a pupil size of the user (e.g., user 102). At operation 606, the user interface visibility module 220 determines a background color of the background region. At operation 608, the user interface visibility module 220 determines the color of the virtual user interface (or GUI) based on the ambient light, the pupil size, and the background color. At operation 610, the user interface visibility module 220 adjusts the shape, color, brightness, or location of the virtual user interface.

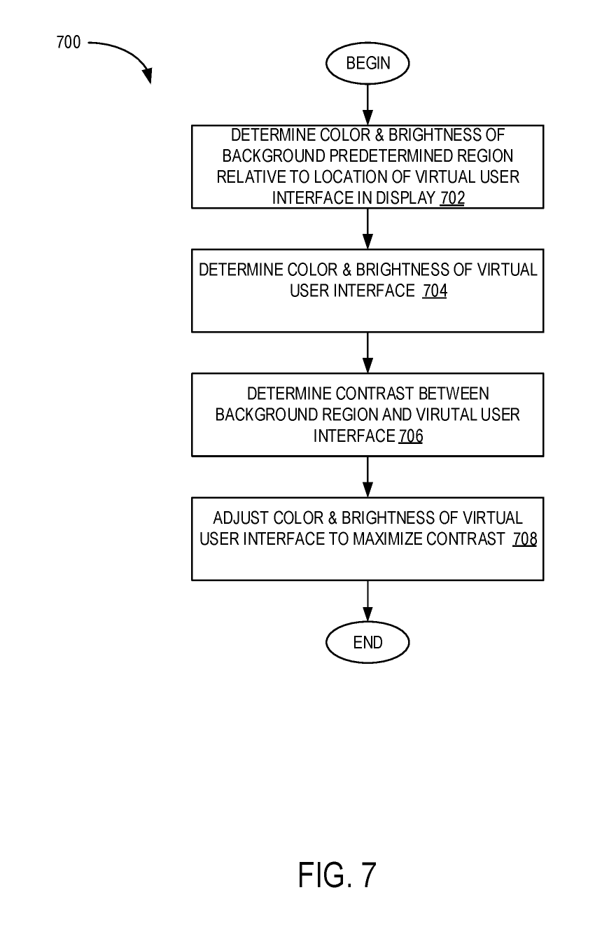

FIG. 7 is a flowchart illustrating a method 700 for adjusting an appearance of a user interface, according to another example embodiment. At operation 702, the user interface visibility module 220 determines a color and brightness of a background predetermined region related to the original location of the virtual user interface in the display 204. At operation 704, the user interface visibility module 220 determines the color and brightness of the virtual user interface in the display 204. At operation 706, the user interface visibility module 220 determines a contrast level between the background region and the virtual user interface. At operation 708, the user interface visibility module 220 adjusts the color and brightness of virtual user interface to maximize contrast.

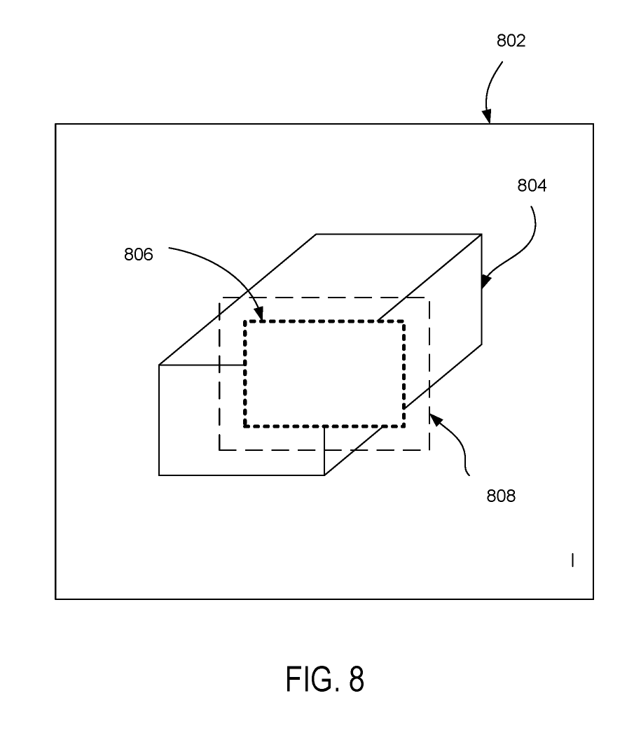

FIG. 8 is a block diagram illustrating an example of adjusting a visibility of a user interface, according to some example embodiments. The background region sensor 306 generates an image 802 with a field of view that corresponds or includes a field of view of the user 102. A GUI 806 is to be displayed over a physical object 804. The background region 808 includes an area around the GUI 806. For example, the area includes a region with similar shape (e.g., rectangle) extending by a predetermined amount around the GUI 806. Therefore, the background region 808 includes portions of the physical object 804. Visual properties of the background region 808 include color, ambient light, brightness, shape, pattern of the portion of the physical object 804. Visual properties of the GUI 806 include for example, color, brightness, shape, font selection, font size, and visual theme. Therefore, the color of the GUI 806 can be changed based on the color of the portion of the physical object 804 located inside the background region 808. In another example, the GUI 806 is displayed at another location (e.g., below the physical object 804) to provide more contrast. The GUI 806 can be made smaller or bigger relative to the size and shape of the physical object 804 to provide more contrast and increase visibility.

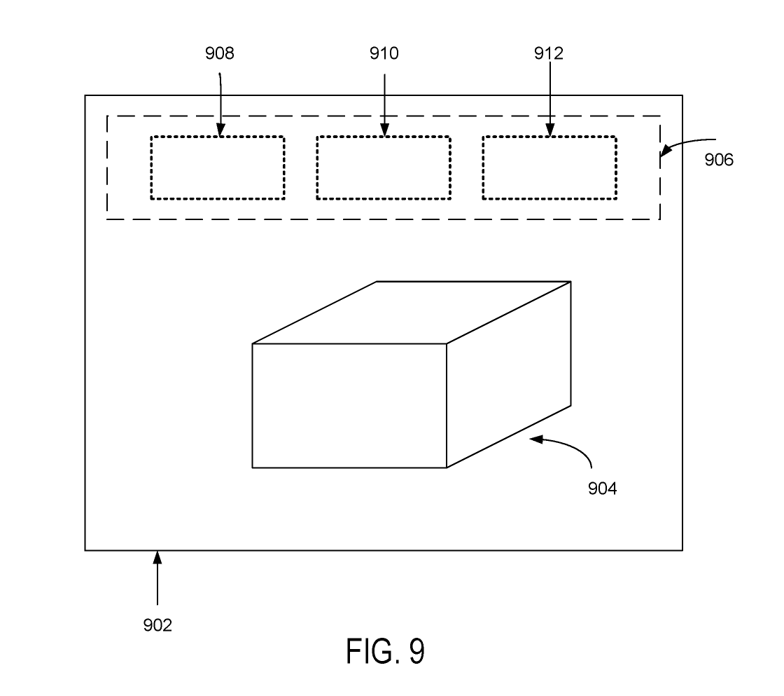

FIG. 9 is a block diagram illustrating another example of adjusting a visibility of a user interface, according to some example embodiments. GUIs 908, 910, and 912 are displayed to be perceived to the user 102 as above the physical object 904. The HMD 101 captures an image 902 that includes the physical object 904. The background region sensor module 406 identifies a background region 906 that includes the areas around GUIs 908, 910, 912. The user interface display controller 408 adjusts the color, font, shape, size, brightness of the GUIs 908, 910, 912 based on the visual properties of the GUIs 908, 910, 912 and the visual properties of the background region 906. For example, if the background region 906 is dark, the user interface display controller 408 selects white fonts for text in the GUIs 908, 910, 912 and increases the brightness of the text. The user interface display controller 408 dynamically adjusts the color, font, shape, size, brightness of the GUIs 908, 910, 912 based on updated visual properties of the background region 906. Therefore, as the user 102 moves his/her head around, the color, font, shape, size, brightness of the GUIs 908, 910, 912 can change to increase their visibility.

### EXAMPLES

Thierry include the claims as examples in all the Daqri apps so that there is verbatim support in the detailed description should they decide to foreign file.

Also I think your should be including some pseudo code after each method flow chart.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor 212 or a group of processors 212) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 212 or other programmable processor 212) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 212 configured using software, the general-purpose processor 212 may be configured as respective different hardware modules at different times. Software may accordingly configure a processor 212, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors 212 that are temporarily configured (e.g., by software) or permanently configured to perform the relevant operations. Whether temporarily or permanently configured, such processors 212 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 212 or processor-implemented modules. The performance of certain of the operations may be distributed among the one or more processors 212, not only residing within a single machine, but deployed across a number of machines. In some example embodiments, the processor or processors 212 may be located in a single location (e.g., within a home environment, an office environment or as a server farm), while in other embodiments the processors 212 may be distributed across a number of locations.

The one or more processors 212 may also operate to support performance of the relevant operations in a “cloud computing” environment or as a “software as a service” (SaaS). For example, at least some of the operations may be performed by a group of computers (as examples of machines including processors 212), these operations being accessible via a network 108 and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 212, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 108.

In example embodiments, operations may be performed by one or more programmable processors 212 executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers 110. A client and server 110 are generally remote from each other and typically interact through a communication network 108. The relationship of client and server 110 arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 212), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 10 is a block diagram of a machine in the example form of a computer system 1000 within which instructions 1024 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server 110 or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions 1024 (sequential or otherwise) that specify actions to be taken by that machine. Further, while only a single machine is illustrated, the term “machine” shall also be taken to include any collection of machines that individually or jointly execute a set (or multiple sets) of instructions 1024 to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation (or cursor control) device 1014 (e.g., a mouse), a disk drive unit 1016, a signal generation device 1018 (e.g., a speaker) and a network interface device 1020.

### Machine-Readable Medium

The disk drive unit 1016 includes a computer-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting computer-readable media 1022. The instructions 1024 may also reside, completely or at least partially, within the static memory 1006.

While the computer-readable medium 1022 is shown in an example embodiment to be a single medium, the term “machine-readable medium” may include a single medium or multiple media (e.g., a centralized or distributed database, and/or associated caches and servers 110) that store the one or more instructions 1024 or data structures. The term “computer-readable medium” shall also be taken to include any tangible medium that is capable of storing, encoding or carrying instructions 1024 for execution by the machine and that cause the machine to perform any one or more of the methodologies of the present embodiments, or that is capable of storing, encoding or carrying data structures utilized by or associated with such instructions 1024. The term “computer-readable medium” shall accordingly be taken to include, but not be limited to, solid-state memories, and optical and magnetic media. Specific examples of computer-readable media 1022 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks 1026 include a LAN, a WAN, the Internet, mobile telephone networks, POTS networks, and wireless data networks (e.g., Wi-Fi and WiMAX networks). The term “transmission medium” shall be taken to include any intangible medium capable of storing, encoding, or carrying instructions 1024 for execution by the machine, and includes digital or analog communications signals or other intangible media to facilitate communication of such software.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The following enumerated embodiments describe various example embodiments of a pressing device discussed herein.

A first embodiment provides a device comprising:

a display configured to display an augmented reality (AR) content;
an optical sensor configured to capture an image;
one or more hardware processors; and
a memory storing instructions that, when executed by the one or more hardware processors, configure the device to perform operations comprising:
determining visual properties of a region in the image, the region
being adjacent to a portion of the AR content;
determining visual properties of the AR content;
determining a contrast between the region in the image and the
AR content based on the visual properties of the region in the image and the visual properties of AR content; and
causing the display to modify an appearance of the AR content based on the contrast.

A second embodiment provides a device according to the first embodiment, wherein the region includes an area larger than an area of the AR content, the area including the AR content.

A third embodiment provides a device according to the first embodiment, wherein the visual properties of the region include a color of the region, a brightness of the region, and a visual pattern of content in the region,

A third embodiment provides a device according to the first embodiment, wherein the visual properties of the AR content include a color of the AR content, a brightness of the AR content, and a visual pattern of the AR content.

A fourth embodiment provides a device according to the first embodiment, wherein the contrast includes a color difference level, a brightness difference level, and a visual pattern difference level.

A fifth embodiment provides a device according to the first embodiment, wherein modifying the appearance of the AR content further comprises:

changing a shape, a color, and a brightness of the AR content in response to the contrast being below a predefined threshold contrast.

A sixth embodiment provides a device according to the fifth embodiment, further comprising:

changing a font of a text in the AR content;
increasing a font size of the text in the AR content; and
changing a color of the text in the AR content.

A seventh embodiment provides a device according to the first embodiment, further comprising:

measuring an ambient light outside the device; and
adjusting a font and a color of the AR content in response to the measured ambient light.

An eighth embodiment provides a device according to the first embodiment, further comprising:

changing a location of the AR content within the display in response to the contrast being below a predefined threshold contrast.

A ninth embodiment provides a device according to the first embodiment, further comprising:

adjusting the appearance of the AR based on output data from neuro sensors or biological sensors connected to a user of the device.

A tenth embodiment provides a device according to the first embodiment, wherein the operations further comprise:

identifying an object in the image;
retrieving the AR content corresponding to the identified object; and
rendering the AR content in the display, the AR content displayed as an overlay on the identified object, the display including a transparent display.

What is claimed is:

1. A device comprising:
a display configured to display an augmented reality (AR) content;
an optical sensor configured to capture an image;
one or more hardware processors; and
a memory storing instructions that, when executed by the one or more hardware processors, configure the device to perform operations comprising:
determining visual properties of a region in the image, the region being adjacent to a portion of the AR content;
determining visual properties of the AR content;
determining a contrast between the region in the image and the AR content based on the visual properties of the region in the image and the visual properties of AR content; and
causing the display to modify an appearance of the AR content based on the contrast.

2. The device of claim 1, wherein the region includes an area larger than an area of the AR content, the area including the AR content.

3. The device of claim 1, wherein the visual properties of the region include a color of the region, a brightness of the region, and a visual pattern of content in the region,
wherein the visual properties of the AR content include a color of the AR content, a brightness of the AR content, and a visual pattern of the AR content.

4. The device of claim 1, wherein the contrast includes a color difference level, a brightness difference level, and a visual pattern difference level.

5. The device of claim 1, wherein modifying the appearance of the AR content further comprises:
changing a shape, a color, and a brightness of the AR content in response to the contrast being below a predefined threshold contrast.

6. The device of claim 5, further comprising:
changing a font of a text in the AR content;
increasing a font size of the text in the AR content; and
changing a color of the text in the AR content.

7. The device of claim 1, further comprising:
measuring an ambient light outside the device; and
adjusting a font and a color of the AR content in response to the measured ambient light.

8. The device of claim 1, further comprising:
changing a location of the AR content within the display in response to the contrast being below a predefined threshold contrast.

9. The device of claim 1, further comprising:
adjusting the appearance of the AR based on output data from neuro sensors or biological sensors connected to a user of the device.

10. The device of claim 1, wherein the operations further comprise:
identifying an object in the image;
retrieving the AR content corresponding to the identified object; and
rendering the AR content in the display, the AR content displayed as an overlay on the identified object, the display including a transparent display.

11. A method comprising:
determining, using one or more hardware processors, visual properties of a region of an image generated with an optical sensor of an augmented reality (AR) device, the region being adjacent to a portion of an AR content displayed in a display of the AR device;
determining, using the one or more hardware processors, visual properties of the AR content;
determining using the one or more hardware processors, a contrast between the region in the image and the AR content based on the visual properties of the region in the image and the AR content; and
causing a display to modify an appearance of the AR content based on the contrast.

12. The method of claim 11, wherein the region includes an area larger than an area occupied by the AR content, the area including the AR content.

13. The method of claim 11, wherein the visual properties of the region include a color of the region, a brightness of the region, and a visual pattern of content in the region,
wherein the visual properties of the AR content include a color of the AR content, a brightness of the AR content, and a visual pattern of the AR content.

14. The method of claim 11, wherein the contrast includes a color difference level, a brightness difference level, and a visual pattern difference level.

15. The method of claim 11, wherein modifying the appearance of the AR content further comprises:
changing a shape, a color, and a brightness of the AR content in response to the contrast being below a predefined threshold contrast, the AR content including a graphical user interface.

16. The method of claim 15, further comprising:
changing a font of a text in the AR content;
increasing a font size of the text in the AR content; and
changing a color of the text in the AR content.

17. The method of claim 11, further comprising:
measuring an ambient light outside the AR device; and
adjusting a font and a color of the AR content in response to the measured ambient light.

18. The method of claim 11, further comprising:
changing a location of the AR content within the display in response to the contrast being below a predefined threshold contrast.

19. The method of claim 11, further comprising:
adjusting the appearance of the AR based on output data from neuro sensors or biological sensors connected to a user of the device.

20. A non-transitory machine-readable medium comprising instructions that, when executed by one or more processors of a machine, cause the machine to perform operations comprising:
determining visual properties of a region of an image generated with an optical sensor of an augmented reality (AR) device, the region being adjacent to a portion of an AR content displayed in a display of the AR device;
determining visual properties of the AR content;
determining a contrast between the region in the image and the AR content based on the visual properties of the region in the image and the AR content; and
modifying an appearance of the AR content based on the contrast.
